(19) United States
(12) Patent Application Publication
(10) Pub. No.: US 2012/0307072 A1
(43) Pub. Date: Dec. 6, 2012

(54) STORAGE SYSTEM FOR STORING AND ORDERNG ARTICLES, IN PARTICULAR PHARMACY ARTICLES

(76) Inventor: Michael Folk, Jesewitz (DE)

(21) Appl. No.: 13/577,054

(22) PCT Filed: Jan. 25, 2011
(86) PCT No.: PCT/DE2011/075011

§ 371 Date: Aug. 3, 2012

(30) Foreign Application Priority Data
Feb. 4, 2010 (DE) 10 2010 001 569.5

(51) Int. Cl. H04N 7/18

(52) U.S. Cl. 348/159; 348/E07.085

(57) ABSTRACT

The invention relates to a storage system for storing and ordering articles (6), in particular pharmacy articles, comprising several filling chutes (4) that substantially run vertically in a row (2, 3) next to each other with each filling chute (4) having a filling hole (8) extending substantially over the entire height of the filling chute (4) and by means of which the articles to be ordered can be introduced into the filling chute (4). Here it is provided, that the storage system (1) comprises at least one camera (9, 10) directed to the filling hole (8) of at least one filling chute (4) and continuously taking pictures of the filling hole (8) and, if present, the articles (6) present in the filling chute (4); and that the storage system (1) further comprises an electronic data processing system connected to at least one camera (9, 10), wherein a software, that extracts information about the number of articles (6) present in the filling chute (4) from the pictures transmitted from the at least one camera (9, 10), is stored in the data processing system.

The invention relates to a storage system for storing and order picking articles, in particular pharmacy articles.

A method and a device for the storage of pharmacy articles are known from DE 43 18 341 B4. With this method it should be possible to optimally store pharmacy articles in a stock. The articles arriving in the stock in cardboard boxes are removed there, heaped up on a conveyor line, and supplied to an isolating device. Subsequently, the bar code of the article is identified by means of a bar-code reader that is usually located at the narrow sites of the article. That's why the conveying device should have transparent faces through which the bar-code reader is to detect the bar codes. Then, the identified articles are measured by means of optical measuring devices using for example three CCD cameras (charge-coupled device cameras) detecting the space coordinates of the article. Both the identity of the article and its space coordinates are transmitted to a computer where also all depositories of the stock are stored. The stock is a drawer storage the drawers of which can be extended and retracted by means of telescopic arms. The computer assigns the optimum depository to the article. The article is removed from the conveyor belt by means of a robot and put on its predetermined depository. When the article is now ordered by the pharmacist it is put from the depository onto the conveyor line by means of the robot. At the same time, the computer receives a signal that the depository is free again. The arrival of the article in the salesroom of the pharmacy is established by a light barrier.

However, in practice the procedure described in DE 43 18 341 B4 is susceptible to failure. Mistakes in storing the article at the depository or removing the article cause a deviation in the number and identity of the actually present articles from the data stored in the computer. However, the device offers no possibility to establish which articles are actually present at the depositories. For that, a human inspection of the depositories is required which in turn requires a disruption of order picking and a subsequent inspection by an employee of the pharmacy due to the structure of the stock and the intended procedure for sizing the articles.

DE 10 2008 027 646 A1 discloses an automated storage system for small parts where the small parts are detected by cameras before storage and the pictures are analyzed by an electronic data processing system. The storage system has several shelves that can be individually ordered and transmitted by a paternoster system to a supplying place serving to supply or remove articles. At the supplying place there is provided a table-like storage area onto which articles are put before storage into the ordered shelf. The cameras for detecting the articles are arranged in the ceiling area of the storage system above the supplying place or at the side walls of the storage system with these cameras are directed to the storage area. There is an area defined by a mark in which the articles are to be positioned in order to ensure an optimum detection by the cameras directed to the storage area. With the cameras above the supplying place and the cameras directed to the storage area the articles and their dimensions should be identified and a free depository in the shelf upon storing should be determined. Removal of articles from an ordered shelf should be done in the same way. For that, the pictures taken by the cameras are analyzed by software stored on the computer. A picture record should always automatically occur before the shelf present at the supplying place is transported back to its actual depository in the storage system again, In this way, operator errors should be excluded.

According to DE 10 2008 027 646 A1 a completely automated order picking of articles is extremely complex so that in practice order picking must always be performed by workforce. However, by definition, this is error-prone which in turn requires regular stocktakings.

It is true that the solution suggested in DE 10 2008 027 646 A1 may detect the storage and removal of articles in and from a shelf. respectively. However, this requires that the shelf be actually ordered. What after the immediate access to a shelf is actually present in the storage vessels there is unknown. Access must be made on a more or less old picture or on data gathered from this old picture. To get a current picture the concerning shelf must be ordered. Moreover, upon storing the detection of a picture of the article by the camera directed to the storage area and the subsequent detection of a picture of the articles stored in the shelf is costly because a number of cameras is required at different positions which increases the demands on the software required for data processing.

DE 10 2006 047 956 discloses an apparatus for monitoring the filling level of parcel goods in the machine shafts of an order picking system. The apparatus comprises a camera that is directed to a machine shaft. To determine the number of articles in the machine shaft there is taken a picture of the machine shaft, and pictorial data are transmitted to an analyzing unit. By comparison of the pictorial data with reference data statements about the height of the filling level should be made. Alternatively. reference marks are fixed in the machine shafts which depending on the filling level are covered by the articles or lie exposed. On the basis of these reference marks there may be made statements about the filling level by means of image-processing programs. However, in both cases a reference system is required, either reference data or reference marks, what is associated with additional efforts and increases the fault liability.

Object of the invention is to eliminate the disadvantages of the prior art. In particular, there is provided a storage system for storing and order picking articles, especially pharmacy articles, that allows a permanent and reliable summary of the number of articles present in a storage unit, for example a filling chute. Further provided is a method that allows a more accurate monitoring of the stock of articles in the storage system.

This object is solved by the features of claims 1 and 8. Practical embodiments of the inventions result from the features of claims 2 to 7 as well as 9 and 10.

According to the invention a storage system for storing and order picking articles, in particular pharmacy articles is provided that comprises several filling chutes that substantially run vertically in a row next to each other with each filling chute having a filling hole extending substantially over the entire height of the filling chute and by means of which the articles to be order picked can be introduced into the filling chute. The storage system further comprises at least one camera that is directed to the filling hole of at least one filling chute and continuously takes pictures of the filling hole and, if present, of the articles present in the filling chute. In addition, the storage system comprises an electronic data processing system that is connected to the at least one camera, wherein a software, that extracts information about the number of articles present in the filling chute from the pictures transmitted by the at least one camera, is stored in the data processing system.

According to the invention there are provided one or more cameras that are directed to the filling holes of the filling chutes. Said cameras continuously produce pictures of the filling holes. These pictures are analyzed by means of software stored in the data processing system. A mathematic algorithm stored in the software is used to ascertain information about the number of articles in each of the filling chutes. The phrase “information about the number of articles in each of the filling chutes” in particular means the number of articles in one filling chute. However, it is not mandatory to ascertain the number of articles. For example, it may be sufficient to ascertain from the pictures the filling height in the filling chutes. Then, from the dimensions of the articles that are also stored in the data processing system the number of articles can be calculated.

In contrast to the prior art, no reference systems such as earlier reference data records or reference marks are required. Rather, the number of articles in one or more filling chutes can be calculated from each picture without having to fall back to earlier pictures or marks. In this way, a comparison between current data and reference data to establish information about the number of articles in each of the filling chutes is avoided, In this way. a higher reliability of the results is achieved since these are independent of a reference system. At the same time a more rapid establishment of information and a simplification of the apparatus are achieved.

Preferably, the information about the number of articles in each of the filling chutes are obtained by metrological triangulation methods by means of the camera(s) and by software adapted thereto.

A plurality of rows of filling chutes may be provided. Per row of filling chutes at least one camera is provided.

The storage system according to the invention allows a permanent monitoring of the filling level of the articles in the filling chutes. Thus, monitoring is not limited to the time of the storage or handing out of an article. Therefore, at any time the actual filling levels are known which greatly reduces the occurrence of errors upon storing and order picking. Changes of the filling levels are detected immediately, i.e. in real time or almost real time. In particular, all changes of the filling levels are detected, for example those resulting from malfunctions or manipulations of the storage system. A further advantage of the storage system according to the invention is that the individual storing units, here the filling chutes, need not be moved to determine the number of articles therein.

Preferably. one camera each is assigned to each filling chute. Here, the number of cameras may be smaller than the number of filling chutes, for example, if one camera takes pictures of several filling chutes. The cameras may be stationary or movable cameras.

If several cameras are provided these are preferably arranged at the same height. In case of stationary cameras, the distances between the cameras and the filling holes to which they are directed are preferably the same. The stationary cameras may be fixed on a wall facing the filling holes. Also, the cameras may he fixed on a stand. For example a brace extending from the bottom to the ceiling of the room wherein the storage system is located.

In case of one or more movable cameras preferably a rail is provided on which the cameras are carried movably along the rail. Here, a camera may be moved from a first position which is opposite to the filling hole of a first filling chute of a row in a second position which is opposite the filling hole of a second filling chute of this row.

If only one camera is provided this covers each of the filling chutes of the row along the rail. When it reaches the outer filling chute at one end of the storage system it changes its moving direction by 180° and moves to the outer filling chute at the other end of the storage system. Preferably, the rail runs in the horizontal and extends from an outer filling chute at one end of the row of filling chutes to the outer filling chute at the other end of this row of filling chutes. The movement of the camera is controlled via control signals produced by the data processing system and transmitted to the camera.

Transmission of the pictures detected by the cameras to the data processing system may be transmitted as known wireless and/or by wires. In the same way, the control signals can be transmitted from the data processing system to the camera.

The storage system according to the invention may further comprise a display terminal on which the number of articles present in the filling chute is shown for each filling chute.

In the present invention, the term “substantially vertically running filling chutes” is to be understood such that the filling chutes run in the vertical or inclined to the vertical.

In the present invention, the term “filling hole substantially extending over the entire height of the filling chute” is to be understood such that the filling hole extends over the entire height of the filling chute, i.e. from the lower to the higher end of the filling chute. So, the filling hole forms a long side of a filling chute. However, connection components may be provided at the ends of the filling chute such that the filling hole is formed above the lower end or below the higher end. respectively. The filling holes of all filling chutes are at the storage filling side. That is the side of the storage sys e through which the articles are filled into the filling chutes.

The storage system may comprise further components known in the prior art. In particular, the storage chutes can comprise at their lower ends, i.e. at the bottom, a means for handing out the article onto a conveyor belt, for example an ejector. At said bottom a sensor can be positioned in a known manner that puts out a signal if no more articles are in the filling chute. Such a signal is a confirmation of the information that already results from the pictures taken by the camera and the pictures analyzed in the data processing system.

Also the parallel detection of the articles handed out by the filling chutes known from the prior art may be used to verify the results obtained from the pictures. Handing out of the article from the filling chute is not detected by the camera, but is also reported by the output unit to the data processing system. If in a comparison of these information discrepancies are found then an alert can be triggered. Thus, an immediate control by the staff may promptly correct errors what further reduces the fault liability of the storage system.

According to the invention there is further provided a method for monitoring the storage system for storing and order picking articles, in particular pharmacy articles according to the invention. In this method, the pictures of the filling hole and, if present, the articles present in the filling chute detected by the camera are transmitted to the data processing system and there, by means of a mathematic algorithm information about the number of articles present in the filling chute are extracted. Preferably, the number of articles present n each of the filling chutes in stored in the data processing system. Particularly preferably an alert is trig-red if the number of articles in a filling chute falls below a prescribed amount. Further. according to said method it may be provided that the data processing system generates control signals by means of which the movement of the camera from the first position to the second position along the rail is controlled.

In the following, the invention is explained in more detail with the help of examples that are not intended to limit the invention with respect to the drawings. Here

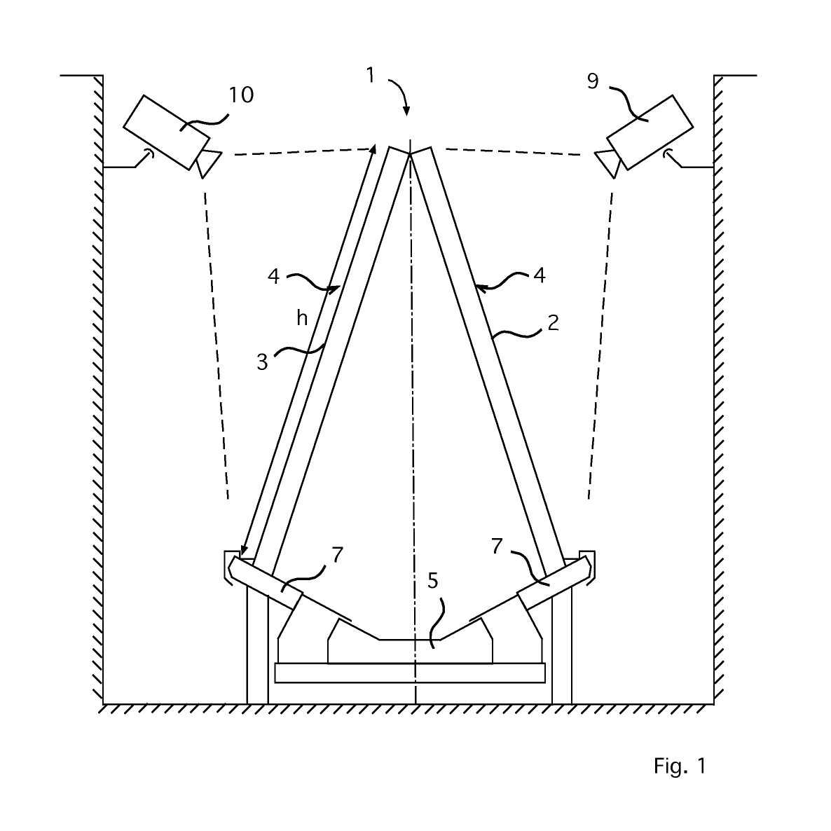

FIG. 1 shows a schematic front elevation of an embodiment of the storage system according to the invention;

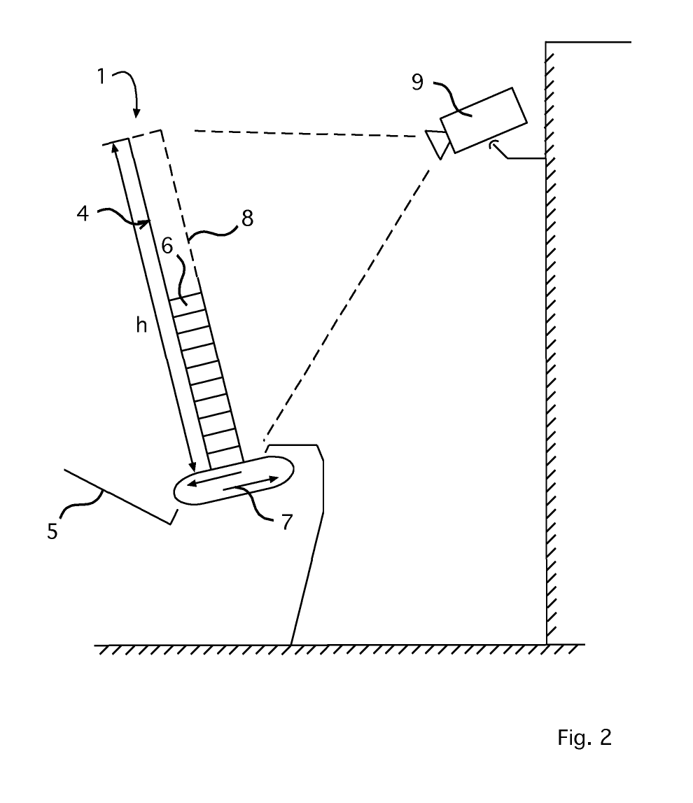

FIG. 2 shows a schematic sectional view of the embodiment of the storage system according to the invention shown in FIG. 1; and

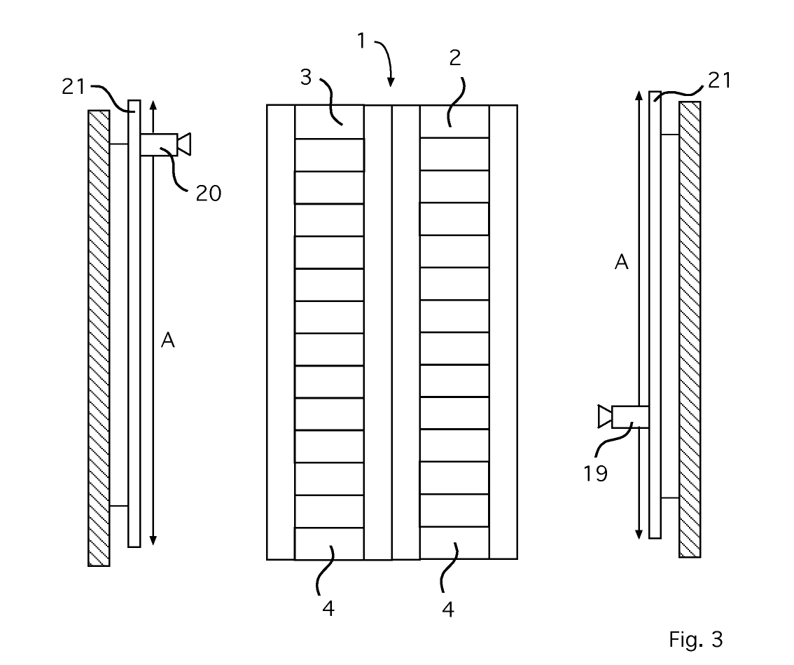

FIG. 3 shows a schematic top view of a further embodiment of the storage system according to the invention.

The embodiments of a storage system 1 according to the invention shown in FIGS. 1 to 3 comprise two rows 2, 3 of adjacent filling chutes 4. It can be seen that the filling chutes are arranged slightly inclined to the vertical. Under the filling chutes 4 there is a conveyor belt 5 onto which the articles 6 (see, FIG. 2) can be delivered via an output unit 7 formed at the lower end of the filling chute 4. The filling chutes 4 at the side turned away from the conveyor belt 5 have filling holes 8 extending over the entire height of the filling chutes 4. The height of the filling chutes is indicated with “h” in FIG. 2.

The filling holes 8 of all filling chutes 4 of a row 2, 3 are the storage filling sides of the storage system, i.e. turned to the outsides. The staff moves at the storage filling sides and fills the articles 6 in the filling chutes 4 via their filling holes 8 with the first article in a filling chute 4 lies on its lower end and is in contact with the output unit 7 such that upon receiving a signal by the data processing system it can be delivered onto the conveyor belt 5 (see, in particular FIG. 2). The subsequent articles 6 are stacked onto said first article.

Opposite to each row 2, 3 of filling chutes 4 a camera 9, 10 is arranged. Camera 9 is directed to the first row 2 of filling chutes, while camera 10 is directed to the second row of filling chutes. The cameras 9, 10 continuously take pictures of the filling holes 8 and, in case that articles are present in the filling chutes 4, of the articles 6.

The taken pictures are wireless transmitted to the data processing system (no(shown) and there analyzed by mathematic algorithms of a software. Here, the number of articles 6 in each filling chute 4 is determined. The thus obtained number of articles 6 per filling chute 4 is stored. The stored value is continuously updated as soon as a new picture showing this filling chute has been analyzed. With that, the number of articles 6 per filling chute 4 is obtained from the new picture without having to fall back to a reference system such as for example earlier pictures.

In FIGS. 1 and 2 the cameras 9, 10 are fixed on the walls. In the embodiment shown in FIG. 3 cameras 19, 20 are fixed on horizontal rails 21. The rails are fixed on the walls opposite to the filling holes. Cameras 19, 20 are movably carried on the rails 21 along the arrow-head direction A and by means of control signals which they receive from the data processing system can be moved to a position allowing to take a picture of a prescribed filling chute 4. Subsequently, cameras 19, 20 are moved to the next prescribed position. The movement may be continuous if the software stored in the data processing system can analyze motion pictures. Also such software is known.

It is not mandatory for the cameras 9, 10 or the rails 21 to be fixed on the walls. Rather, any attachment may be provided, for example to scaffolds or racks. as long as the cameras can be directed to the filling holes 8.

### LIST OF REFERENCE MARKS

1 Storage System

2 First Row of Filling Chutes

3 Second Row of Filling Chutes

4 Filling Chute

5 Conveyor belt

6 Article

7 Output Unit

8 Filling Hole

9 First Camera

10 Second Camera

19 First Camera

20 Second Camera

21 Rail

h Height of a Filling Chute 4

A Movement Direction of the Camera on the Rail 21

1-10. (canceled)

11. A storage system for storing and ordering associated articles (6) having dimensions, comprising:
first and second filling chutes (4) that are positioned substantially vertically (2, 3) and adjacent each other, wherein each of the first and second filling chutes (4) has a height, a number of associated articles (6) and a filling hole (8) extending substantially over the entire height of the filling chute (4), wherein the associated articles (6) are inserted into the first and second filling chutes (4) through the filling holes (8);
a first camera (9, 10) that is directed toward the filling hole (8) of at least one of the first and second filling chutes (4) and that continuously takes pictures of the filling hole (8) and, if present, the articles (6) present in the filling chute (4);
an electronic data processing system operatively connected to the first camera (9, 10);
wherein data concerning the dimensions of the articles (6) is stored in the electronic data processing system;
wherein software that determines a filling height for the at least one of the first and second filling chutes (4) from pictures transmitted by the first camera (9. 10) to the data processing system by means of triangulation methods is stored in the electronic data processing system; and,
wherein the electronic data processing system determines the number of articles (6) present in the at least one of the first and second filling chutes (4) by means of the stored data and the determined filling height.

12. The storage system according to claim 11 wherein:
the first camera is directed toward the filling hole (8) of the first filling chute (4) and continuously takes pictures of the filling hole (8) of the first filling chute (4) and, if present, the articles (6) present in the first filling chute (4);
a second camera is directed toward the filling hole (8) of the second filling chute (4) and continuously takes pictures of the filling hole (8) of the second filling chute (4) and, if present, the articles (6) present in the second filling chute (4);
wherein the software determines the filling height for each of the first and second filling chutes (4) from pictures transmitted by the first and second cameras (9, 10) to the data processing system by means of triangulation methods; and,
wherein the electronic data processing system determines the number of articles (6) present in the first and second filling chutes (4) by means of the stored data and the determined filling heights.

13. The storage system according to claim 12 wherein:
the first and second cameras (9, 10) are positioned at substantially the same height;
the first camera is positioned at a first distance from the filling hole of the first chute;
the second camera is positioned at a second distance from the filling hole of the second chute; and,
the first and second distances are substantially the same.

14. The storage system according to claim 12 further comprising:
a first rail (21) on which the first camera (19) is movably carried; and,
a second rail (21) on which the second camera (20) is movably carried.

15. The storage system according to claim 14 wherein:
the first and second rails are positioned substantially in a vertical orientation.

16. The storage system according to claim 11 further comprising:
a rail (21) on which the first camera (19, 20) is movably carried; and,
wherein the first camera 19, 20) is moveable along the rail (21) between a first position which is directed toward the filling hole (8) of the first filling chute (4) to a second position which is directed toward the filling hole (8) of the second filling chute (4).

17. The storage system according to claim 16 wherein:
the rail (21) is positioned substantially in a horizontal orientation.

18. The storage system according to claim 16 wherein:
the data processing system produces control signals for moving the first camera (19, 20) from the first position to the second position and sends them to the first camera (19, 20).

19. The storage system according to claim 11 further comprising:
a display terminal on which the number of associated articles (6) present in the filling chute (4) for each of the first and second filling chutes is shown.

20. A method for monitoring a storage system comprising the steps of:
(A) providing a storage system (1) for storing and ordering associated articles (6) having dimensions, comprising: first and second filling chutes (4) that are positioned substantially vertically (2, 3) and adjacent each other, wherein each of the first and second filling chutes (4) has a height, a number of associated articles (6) and a filling hole (8) extending substantially over the entire height of the filling chute (4);
(B) providing a first camera (9, 10) that is directed toward the filling hole (8) of at least one of the first and second filling chutes (4);
(C) providing an electronic data processing system operatively connected to the first camera (9, 10);
(D) taking pictures of the filling hole (8) and. if present, the articles (6) present in the filling chute (4) with the first camera;
(E) transmitting the pictures to the electronic data processing system; and,
(F) using the electronic data processing system to: determine a filling height for the at least one of the first and second filling chutes (4) from the pictures by means of triangulation methods stored in the electronic data processing system; and, determine the number of articles (6) present in the at least one of the first and second filling chutes (4) by means of the stored data and the determined filling height.

21. The method of claim 20 further comprising the steps of:
storing in the electronic data processing system the number of articles (6) present he at least one of the first and second filling chutes (4); and,
triggering an alert if the number of articles (6) present in the at least one of the first and second filling chutes (4) falls below a prescribed amount.

22. The method of claim 20 wherein step (D) comprises the step of:
continuously taking pictures of the filling hole (8) and, if present, the articles (6) present in the filling chute (4) with the first camera.

23. The method of claim 20 wherein:
step (B) comprises the step of: directing the first camera toward the filling hole of the first filling chute;
the method further comprises the step of: providing a second camera that is directed toward the filling hole (8) the second filling chute;
step (C) comprises the step of: operatively connecting the second camera to the electronic data processing system;
step (D) comprising the steps of: taking pictures of the filling hole (8) and, if present, the articles (6) present in the first filling chute (4) with the first camera; and, taking pictures of the filling hole (8) and, if present, the articles (6) present in the second filling chute (4) with the second camera;
step (F) comprises the steps of: using the electronic data processing system to: (a) determine the filling height for the first and second filling chutes (4) from the pictures by means of triangulation methods stored in the electronic data processing system; and. (b) determine the number of articles (6) present in the first and second filling chutes (4) by means of the stored data and the determined filling height.

24. The method of claim 23 wherein:
the method further comprises the steps of: providing a first rail on which the first camera is movably carried; and, providing a second rail on which the second camera is movably carried; and,
step (D) comprises the steps of: moving the first camera along the first rail; and, moving the second camera along the second rail.

25. The method of claim 24 wherein:
step (D) comprises the step of: moving the first camera along the first rail and moving the second camera along the second rail in response to control signals produced by the electronic data processing system.

26. The method of claim 20 wherein:
the method further comprises the step of: providing a rail on which the first camera is movably carried;
step (D) comprises the steps of: moving the first camera along the rail between a first position which is directed toward the filling hole (8) of the first filling chute (4) to a second position which is directed toward the filling hole (8) of the second filling chute (4); and, taking pictures of the filling hole (8) and, if present, the articles (6) present in the first and second filling chutes (4) with the first camera; and,
step (F) comprises the steps of: using the electronic data processing system to: (a) determine the filling height for the first and second filling chutes (4) from the pictures by means of triangulation methods stored in the electronic data processing system; and, (b) determine the number of articles (6) present in the first and second filling chutes (4) by means of the stored data and the determined filling height.

27. The method of claim 26 wherein:
step (D) comprises the step of: moving the first camera along the first rail in response to control signals produced by the electronic data processing system.

28. A method for monitoring a storage system of pharmacy articles comprising the steps of:
(A) providing a storage system (1) for storing and ordering pharmacy articles (6) having dimensions, comprising: first and second filling chutes (4) that are positioned substantially vertically (2, 3) and adjacent each other, wherein each of the first and second filling chutes (4) has a height, a number of associated articles (6) and a filling hole (8) extending substantially over the entire height of the filling chute (4);
(B) providing a first camera (9, 10) that is directed toward the filling hole (8) of at least one of the first and second filling chutes (4);
(C) providing an electronic data processing system operatively connected to the first camera (9, 10);
(D) taking pictures of the filling hole (8) and, if present, the pharmacy articles (6) present in the filling chute (4) with the first camera;
(E) transmitting the pictures to the electronic data processing system; and,
(F) using the electronic data processing system to: determine a filling height for the at least one of the first and second filling chutes (4) from the pictures by means of triangulation methods stored in the electronic data processing system; and, determine the number of pharmacy articles (6) present in the at least one of the first and second filling chutes (4) by means of the stored data and the determined filling height.

29. The method of claim 28 further comprising the steps of:
storing in the electronic data processing system the number of pharmacy articles (6) present in the at least one of the first and second filling chutes (4); and,
triggering an alert if the number of pharmacy articles (6) present in the at least one of the first and second filling chutes (4) falls below a prescribed amount.

30. The method of claim 28 wherein step (D) comprises the step of:
continuously taking pictures of the filling hole (8) and, if present, the pharmacy articles (6) present in the filling chute (4) with the first camera.
